(19) United States
(12) Patent Application Publication
(10) Pub. No.: US 2010/0084268 A1
(43) Pub. Date: Apr. 8, 2010

(54) LOW VOLUME ELECTROCHEMICAL BIOSENSOR

(75) Inventors: Robin D. Pierce, Abingdon (GB); Shridhara Alva Karinka, Pleasanton, CA (US); Milind P. Nagale, Lowell, MA (US); Ross D. Meyer, Somerville, MA (US); W. James Scott, Bedford, MA (US); Gurdial Sanghera, Oxford (GB)

Correspondence Address: Abbott Diabetes Care Inc.;Bozicevic, Field & Francis LLP, 1900 University Ave, Suite 200, East Palo Alto, CA, 94303, US

(73) Assignee: Abbott Diabetes Care Inc.

(21) Appl. No.: 12/463,210

(22) Filed: May 8, 2009

Related U.S. Application Data
(63) Continuation of application No. 11/849,803, filed on Sep. 4, 2007.
Application No. 11/849,803 is a continuation of application No. 10/674,695, filed on Sep. 30, 2003.

(51) Int. Cl. G01N 27/26

(52) U.S. Cl. 204/403.14

(57) ABSTRACT

A biosensor in which at least one reagent constitutes a portion of a working electrode, a conductive track leading from a working electrode to an electrical contact associated with a working electrode, or an electrical contact associated with a working electrode. For example, the biosensor can have a mediator or an enzyme or both incorporated into the working electrode itself. Other reagents can be dispensed on the electrode itself either directly or by impregnating a matrix, such as a mesh or a membrane, with the enzyme, and then placing the impregnated mesh or membrane over the electrode. Alternatively, the biosensor can have a mediator or an enzyme or both incorporated into the conductive track leading from the working electrode to an electrical contact associated with the working electrode. In another alternative, the biosensor can have a mediator or an enzyme or both incorporated into the electrical contact associated with the working electrode itself. Furthermore, the biosensor can have a mediator or an enzyme or both incorporated into at least two of the foregoing components of the biosensor.

### BACKGROUND OF THE INVENTION

1. Field of the Invention

This invention relates to electrochemical sensors, more particularly electrochemical sensors for determining the concentration of an analyte in a liquid sample.

2. Discussion of the Art

An electrochemical cell is a device comprising a working electrode and a counter electrode, which electrodes are connected to one another electrically. When in use, electrochemical reactions occurring at each of the electrodes cause electrons to flow to and from the electrodes, thus generating a current. An electrochemical cell can be set up either to harness the electrical current produced, for example in the form of a battery, or to detect electrochemical reactions which are induced by an applied current or voltage.

A biosensor is a type of electrochemical cell, in which the electrode arrangement comprises a working electrode, a reference electrode, and a counter electrode (or in place of the reference electrode and counter electrode, an electrode that functions as both reference electrode and counter electrode). Reagents, e.g., enzyme and mediator, that are required for generating a measurable signal upon electrochemical reaction with an analyte in a sample to be assayed, are placed over the working electrode so that the reagents cover at least a portion of the surface of the working electrode.

In other cases, the biosensor includes a reference electrode comprising, for example, a mixture of silver and silver chloride. The reagents are placed over at least the working electrode. However, placing the reagents over the reference electrode will not influence the electrochemical measurement at the working electrode. For example, a reagent containing a quinone mediator would not react with the silver/silver chloride mixture. A biosensor having this type of mediator makes it possible for reagents to be applied over the working electrode with inaccurate registration of the reagent relative to the working electrode.

In still other instances, the reagents of the biosensor are required to be isolated from substances applied to the reference electrode in order to prevent interaction between the mediator and the substances applied to the reference electrode. In these cases, precise registration of the reagents on the working electrode may be required.

In some cases, the reagents and one inert electrode (such as carbon, palladium, gold) serve as the working electrode of the biosensor, and the reagents and another inert electrode serve as the dual-purpose reference/counter electrode of the biosensor. In these situations, the reagents are required to be placed over both electrodes, because the inert electrodes cannot easily participate in any chemical reaction. For example, if ferricyanide is used as the mediator, it is reduced to ferrocyanide in the presence of glucose. The ferricyanide/ferrocyanide system provides a reference potential at the surface of the inert electrode, and this reference potential is sufficiently stable for assays requiring only a short duration.

In still other instances, the enzyme or mediator or both are immobilized on the surface of the working electrode to prevent diffusion or migration of the reagent between electrodes. Immobilization can be achieved by chemically binding the molecule of interest, such as, for example, an enzyme, to the surface of the electrode. In some instances, the enzyme and mediator are incorporated into a carbon paste electrode packed in a glass tube. A carbon paste electrode formed in a glass tube is not applied to a substrate by printing an ink containing carbon thereon.

The differences between the various types of biosensors are dependent upon the chemical reaction desired. One of ordinary skill in the art can readily modify a given biosensor so as to render it capable of performing the desired chemical reaction.

Conventionally, the reagents are deposited over the working electrode by printing a layer of conductive material over a carbon electrode. Because of diffusion of the electrochemically reactive species, in addition to registration requirements for printing an additional layer, electrode arrangements preferably have electrodes placed on the same substrate. However, placing electrodes on the same substrate, particularly in a side-by-side configuration, often requires the biosensor to consume a relatively large amount of liquid sample in order that the sample can contact all of the electrodes that must be contacted in order to carry out a given chemical reaction. One way to reduce the volume of sample required is to place electrodes on facing substrates separated by a thin spacing layer. Another way to reduce the volume of sample required is to reduce the sizes of the electrodes. On account of registration tolerances, reduction of sizes of electrodes is limited if another layer is to be printed on top of the previously printed electrode. WO2002/054055A1 describes biosensors asserted to have improved sample application and measuring properties. The biosensor has a sample application and reaction chamber facilitating the speed and uniformity of sample application via capillary flow. The biosensor has multiple circuits asserted to lead to improved assay consistency and accuracy.

U.S. Pat. No. 5,229,282 describes a method of preparing a biosensor comprising forming an electrode system mainly containing carbon on an insulating base plate, treating the surface of the electrode system with an organic solvent, and then arranging a reaction layer on the electrode system to give a unified element. The reaction layer contains an enzyme, electron acceptor and a hydrophilic polymer. Treatment with organic solvent improves adhesion of the reaction layer to the electrode system. The electrode system contains a working electrode and a counter electrode. The electrode system is formed from a carbon paste containing a resin binder.

U.S. Pat. No. 5,185,256 describes a biosensor which comprises an insulating base, an electrode system formed on the base, and primarily made of carbon, and a perforated body having an enzyme and an electron acceptor and integrally combined with the electrode system whereby a concentration of a specific component in a biological liquid sample can be electrochemically measured rapidly and accurately by the procedure of addition of liquid sample.

EP0390390 describes an electrochemical enzyme biosensor for use in liquid mixtures of components for detecting the presence of, or measuring the amount of, one or more select components. The enzyme electrode comprises an enzyme, an artificial redox compound covalently bound to a flexible polymer backbone and an electron collector. In one example, a carbon paste was constructed by mixing graphite powder with ferrocene containing polymer, the latter being dissolved in chloroform. After evaporation of the solvent, glucose oxidase and paraffin oil were added, and the resulting mixture blended into a paste. The paste was packed into a recess at the base of a glass electrode holder.

The techniques for reducing the volume of the liquid sample typically involve placing the electrodes very close to one another. However such placement of the electrodes often results in migration of reagents from one electrode to the other, which further results in higher background signals. Higher background signals can often result in inaccurate determinations of the concentration of analyte. It would be desirable to provide a biosensor having an electrode arrangement that would reduce electrochemical feedback resulting from diffusion of mediator between (a) the counter electrode or the dual-purpose reference/counter electrode and (b) the working electrode. It would also be desirable to apply the enzyme and other components of the working electrode by drop coating, spray coating, and dip coating, etc., rather than by printing, thereby allowing for smaller electrode areas, further allowing reduction of sample volumes.

### SUMMARY OF THE INVENTION

In one aspect, this invention provides a biosensor in which at least one reagent constitutes at least a portion of a working electrode, at least a portion of a conductive track leading from a working electrode to an electrical contact associated with a working electrode, or at least a portion of an electrical contact associated with a working electrode, or at least a portion of each of at least two of the foregoing components. For example, the biosensor can have a mediator or an enzyme or both incorporated into the working electrode itself. Other reagents can be dispensed on the electrode itself either directly or by impregnating a matrix, such as a mesh or a membrane, with the enzyme, and then placing the impregnated mesh or membrane over the working electrode. Alternatively, the biosensor can have a mediator or an enzyme or both incorporated into the conductive track leading from the working electrode to an electrical contact associated with the working electrode. In another alternative, the biosensor can have a mediator or an enzyme or both incorporated into the electrical contact associated with the working electrode itself. Furthermore, the biosensor can have a mediator or an enzyme or both incorporated into at least two of the foregoing components of the biosensor.

In another aspect, an enzyme, or a mediator, or both an enzyme and a mediator can be incorporated into a conductive ink that is used to form the working electrode and the conductive track leading from the working electrode to the electrical contact associated with the working electrode. Because the ink used to print the working electrode may adversely affect the enzyme, appropriate modification of the formulation can be carried out to improve the stability of the enzyme in the ink. For example, addition of polyethylene glycol to the ink introduces hydrophilic domains in the ink that will provide a medium where the structure of the enzyme is not significantly altered.

Placement of the reagent(s) in the foregoing manner allows efficient transfer of electrons from the mediator to the bulk of the working electrode because the mediator is in direct contact with the working electrode. When a mediator is applied over the surface of an electrode, only the portion of the mediator at the electrode/mediator interface reacts with the electrode and the remainder of the mediator diffuses away from the electrode. In this invention, all portions of the mediator can be placed in direct contact with the conductive portion of the working electrode. The incorporation of the reagent(s) in the working electrode and the conductive track leading from the working electrode to the contact associated with the working electrode makes it possible for the enzyme to be easily incorporated in the electrode arrangement without the need for accurate positioning of the enzyme component of the reagent(s). Because the mediator can be incorporated into the working electrode, the mediator will not diffuse out of the working electrode, and, consequently, the working electrode and the dual-purpose reference/counter electrode (or the counter electrode in a three-electrode embodiment) can be positioned in close proximity in a planar arrangement (side-by-side) or in an opposing arrangement (face-to-face), without fear of the mediator migrating between the working electrode and the dual-purpose reference/counter electrode (or the counter electrode in a three-electrode embodiment), and consequently interfering in the measurement. This manner of positioning of electrodes will enable fabrication of biosensors capable of operating with low volumes of sample, preferably not exceeding 1 microliter.

The biosensor of this invention allows efficient transfer of electrons from the mediator to the working electrode. The mediator is in close proximity to the electrode for efficient relay of the electrons from the enzyme to the working electrode.

The ability to prevent the mediator from migrating from one electrode to another, along with relaxed print constraints, will allow extreme reduction in size of the biosensor. The working electrode and the counter electrode (or the dual-purpose reference/counter electrode) can be positioned in sufficiently close proximity in a planar arrangement or in an opposing arrangement so that the volume of the liquid sample required can be significantly reduced.

### BRIEF DESCRIPTION OF THE DRAWINGS

FIG. 1 is an exploded perspective view of one embodiment of a biosensor of this invention where the working electrode and the dual-purpose reference/counter electrode are disposed on one substrate.

FIG. 2 is a side view in elevation of the biosensor of FIG. 1.

FIG. 3 is an end view in elevation of the biosensor of FIG. 1.

FIG. 4 is an exploded perspective view of one embodiment of a biosensor of this invention where the working electrode and the dual-purpose reference/counter electrode are disposed on two different substrates.

FIG. 5 is a side view in elevation of the biosensor of FIG. 4.

FIG. 6 is an end view in elevation of the biosensor of FIG. 4.

FIG. 7 is a graph showing the current response of biosensors as a function of concentration of glucose in blood.

### DETAILED DESCRIPTION

As used herein, the term “reagent” means a substance that is needed to interact with an analyte or with the reagent that interacts with the analyte to generate a measurable signal. In the case of determining the concentration of glucose, lactate, ketone bodies, or the like, the reagents include an enzyme and a mediator, and, optionally, a co-enzyme.

The term “arrangement” means the manner in which electrodes are placed in relation to one another. For example, in a planar arrangement, the working electrode and the dual-purpose reference/counter electrode are placed on the same surface of the insulating substrate, whereby the electrodes are in a side-by-side relationship. In an opposing arrangement, there are two substrates in a face-to-face relationship, with one electrode being on one of the two substrates and the other electrode being on the other of the two substrates, whereby the electrodes are in a face-to-face relationship.

As used herein, the term “electrode” refers to that portion of the conductive track that is exposed to the liquid sample containing the analyte of interest; the expression “conductive track” refers to a lead of sufficiently low electrical resistance that connects an electrode to an electrical contact; the term “contact” refers to that portion of the conductive track that can form a removable connection with a measuring device during a measurement of electrical values.

The expression “working electrode” means an electrode where the reaction of interest takes place. The current is proportional to the concentration of an analyte, e.g., glucose, at the working electrode; the expression “reference electrode” refers to an electrode that measures the potential at the interface of the working electrode and the sample as accurately as possible; the expression “counter electrode” refers to an electrode that ensures that the correct potential difference between the reference electrode and the working electrode is being applied; a “dual-purpose reference/counter electrode” is an electrode that acts as a reference electrode as well as a counter electrode. In an ideal reference electrode, no current passes through the reference electrode.

The potential difference between the working electrode and the reference electrode is assumed to be the same as the desired potential at the working electrode. If the potential measured at the working electrode is not the potential desired at the working electrode, the potential that is applied between the counter electrode and the working electrode is altered accordingly, i.e., the potential is either increased or decreased. The reaction at the counter electrode is also equal and opposite to the charge transfer reaction occurring at the working electrode, i.e., if an oxidation reaction is occurring at the working electrode then a reduction reaction will take place at the counter electrode, thereby allowing the sample to remain electrically neutral. No current passes through an ideal reference electrode, and such an electrode maintains a steady potential; current does pass through a dual-purpose reference/counter electrode, and thus, the dual-purpose reference/counter electrode does not maintain a steady potential during the measurement.

At low currents and/or at short durations of time for measurement, the shift in potential is small enough such that the response at the working electrode is not significantly affected, and hence the dual-purpose reference/counter electrode is designated a dual-purpose reference/counter electrode. The dual-purpose reference/counter electrode still carries out its counter electrode function; however, in the case of the dual-purpose reference/counter electrode, the potential that is applied between the dual-purpose reference/counter electrode and the working electrode cannot be altered to compensate for changes in potential at the working electrode.

As used herein, the term “conductive” means electrically conductive. The term “insulating” means electrically insulating. The expression “reaction zone” means the position in the biosensor where an oxidation-reduction reaction takes place. The expression “sample application zone” means the position where a liquid sample is applied to the biosensor.

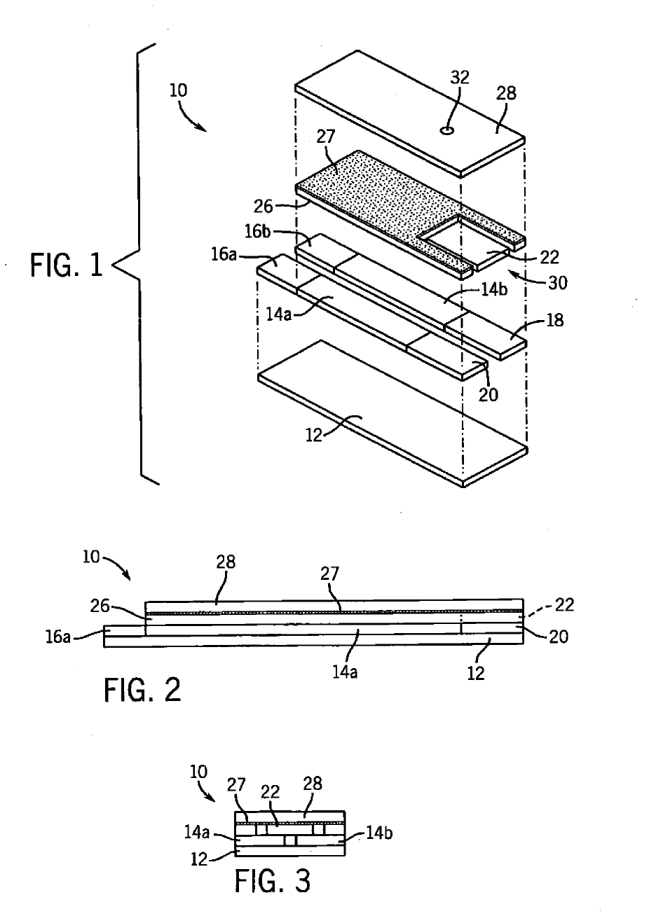

Biosensor strips suitable for this invention are illustrated in FIGS. 1-6. Referring to FIGS. 1-3, a biosensor strip 10 comprises an electrode support 12, which is preferably an elongated strip of polymeric material (e.g., polyvinyl chloride, polycarbonate, polyester, or the like) supports two conductive tracks 14a, 14b, preferably formed from electrically conductive ink, preferably comprising carbon. These tracks 14a, 14b determine the positions of electrical contacts 16a, 16b, a dual-purpose reference/counter electrode 18 and a working electrode 20. The electrical contacts 16a, 16b can be inserted into an appropriate measurement device (not shown) for measurement of current. A layer containing reagent(s) is designated by reference numeral 22.

If the working electrode 20 is lacking a reagent(s) required for a given assay, the reagent(s) can be supplied to the biosensor by means of the layer 22. If the working electrode 20 contains all of the reagents needed to carry out the assay, the layer 22 can be deleted. A layer of an electrically insulating material 26, preferably a hydrophobic electrically insulating material, further overlies the tracks 14a, 14b. The positions of the electrical contacts 16a, 16b are not covered by the layer of electrically insulating material 26. This layer of electrically insulating material 26 serves to prevent short circuits. When this insulating material is hydrophobic, it can cause a hydrophilic liquid sample to be restricted to the exposed electrodes. A preferred insulating material is commercially available as “POLYPLAST” (Sericol Ltd., Broadstairs, Kent, UK). The layer of insulating material 26 has a layer of adhesive material 27 to adhere a layer of tape 28 to the layer of insulating material 26. The layer of tape 28 and the layer of adhesive 27 are optional. A small aperture 32 is present in the layer 28 to function as a vent to allow the liquid sample to flow easily from the sample application zone to the electrodes.

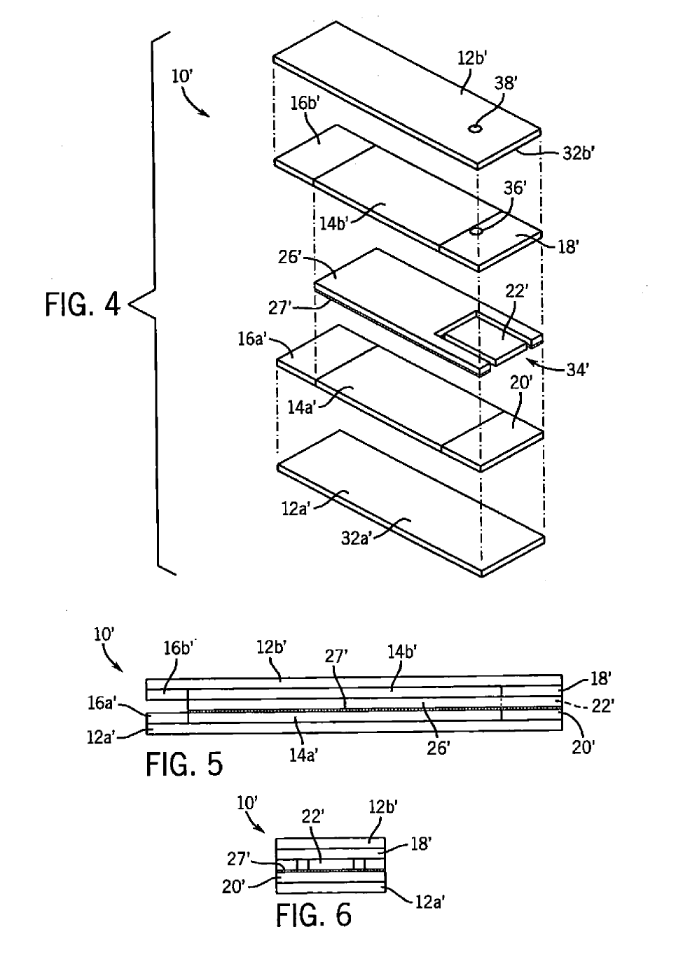

Referring now to FIGS. 4-6, a biosensor strip 10′ comprises a first substrate 12a′, a second substrate 12b′, and conductive tracks 14a′, 14b′ for electrochemical use, preferably formed from electrically conductive ink, preferably comprising carbon. The conductive tracks 14a′, 14b′ determine the positions of electrical contacts 16a′, 16b′, a dual-purpose reference/counter electrode 18′ and a working electrode 20′. The electrical contacts 16a′, 16b′ can be inserted into an appropriate measurement device (not shown) for measurement of current. A layer containing reagent(s) is designated by reference numeral 22′. If the working electrode 20′ is lacking a reagent(s) required for a given assay, the reagent(s) can be supplied to the biosensor by means of the layer 22′. If the working electrode 20′ contains all of the reagents needed to carry out the assay, the layer 22′ can be deleted. The biosensor 10′ further comprises a layer of an electrically insulating material 26′, preferably a hydrophobic electrically insulating material, to delineate a specified sensor area that includes the dual-purpose reference/counter electrode 18′ and the working electrode 20′ and to act as a spacing layer to specify the width and depth of a flow channel 34′. The second substrate 12b′ helps to delineate the flow channel 34′. The sample is caused to flow in the flow channel 34′ by means of capillary attraction. The flow channel 34′ is of such dimensions that the biosensor strip takes up a liquid sample by capillary attraction. See U.S. Ser. No. 10/062,313, filed Feb. 1, 2002, incorporated herein by reference. A small aperture 36′ present in the dual-purpose reference/counter electrode 18′ and a small aperture 38′ present in the second substrate 12b′ function as vents to allow the liquid sample to flow easily from the sample application zone to the electrodes.

Optionally, in either embodiment, a trigger electrode can be placed downstream of the dual-purpose reference/counter electrode. The trigger electrode can be used to determine when the sample has been applied to the strip, thereby activating the assay protocol. See U.S. Ser. No. 09/529,617, filed Jun. 7, 2000, incorporated herein by reference. The trigger electrode prevents the assay from beginning until an adequate quantity of sample has filled the reaction zone. A two-electrode system is described more completely in U.S. Pat. No. 5,509,410, incorporated herein by reference.

In an alternative embodiment (not shown), the dual-purpose reference/counter electrode in the biosensor strip can be replaced by two electrodes—a reference electrode and a counter electrode. Biosensors containing a working electrode, a reference electrode, and a counter electrode separate from a reference electrode are shown in U.S. Publication Number US-2003-0146110-A1, published Aug. 7, 2003, incorporated herein by reference. This alternative embodiment can further include a fourth electrode to act as a trigger electrode to initiate the assay sequence. In the absence of the optional trigger electrode, the counter electrode can be positioned downstream of the working electrode so as to act as a trigger electrode to initiate the assay sequence.

Optionally, in either embodiment, each of the elongated portions of the conductive tracks 14a, 14b, 14a′, 14b′ can be overlaid with a track of conductive material, preferably made of a mixture comprising silver particles and silver chloride particles (not shown).

Optionally, in either embodiment, at least one layer of mesh and at least a second insulating layer can be placed proximate to the reagent layer 22, 22′ to allow the liquid sample to fill the sample application zone by chemically-aided wicking. The layer of mesh can be held in position with the aid of an insulating layer (“POLYPLAST”) or an adhesive layer. If an adhesive layer is used, the adhesive can serve the dual-purpose of holding the layer of tape in position. In the arrangement where the electrodes are disposed face-to-face, the layer of mesh can be placed between the two substrates in the vicinity of the electrodes. Any additional insulating layers include openings formed therein to allow access of the applied sample to the underlying layers of mesh.

According to this invention, at least one reagent can be incorporated into at least one of the working electrode, the conductive track leading from the working electrode to the electrical contact associated with the working electrode, or the electrical contact associated with the working electrode. The following table sets forth some representative examples of the classes of reagents, and the relative amounts thereof, that can be incorporated into the components of the biosensor.

TABLE 1

| | | Working | Conductive | Electrical |
|---|---|---|---|---|
| Bi- | | electrode | track | contact |
| osensor | Material | (% by weight) | (% by weight) | (% by weight) |
| I | Conductive | 95-99 | 95-99 | 95-99 |
| | material | | | |
| | Mediator | 1-5 | 1-5 | 1-5 |
| | Enzyme | 0 | 0 | 0 |
| | Coenzyme | 0 | 0 | 0 |
| | Inactive | 0 | 0 | 0 |
| | materials | | | |
| II | Conductive | 88-98 | 88-98 | 88-98 |
| | material | | | |
| | Mediator | 1-5 | 1-5 | 1-5 |
| | Enzyme | 0 | 0 | 0 |
| | Coenzyme | 1-5 | 1-5 | 1-5 |
| | Inactive | 0-2 | 0-2 | 0-2 |
| | materials | | | |
| III | Conductive | 96-99 | 96-99 | 96-99 |
| | material | | | |
| | Mediator | 0 | 0 | 0 |
| | Enzyme | 0.1-2 | 0.1-2 | 0.1-2 |
| | Coenzyme | 0 | 0 | 0 |
| | Inactive | 0-2 | 0-2 | 0-2 |
| | materials | | | |
| IV | Conductive | 92-99 | 92-99 | 92-99 |
| | material | | | |
| | Mediator | 0 | 0 | 0 |
| | Enzyme | 0.1-1 | 0.1-1 | 0.1-1 |
| | Coenzyme | 0-5 | 0-5 | 0-5 |
| | Inactive | 0-2 | 0-2 | 0-2 |
| | materials | | | |
| V | Conductive | 87-99 | 87-99 | 87-99 |
| | material | | | |
| | Mediator | 1-5 | 1-5 | 1-5 |
| | Enzyme | 0.1-1 | 0.1-1 | 0.1-1 |
| | Coenzyme | 0-5 | 0-5 | 0-5 |
| | Inactive | 0-2 | 0-2 | 0-2 |
| | materials | | | |

In Biosensor I, the enzyme, and, optionally, a co-enzyme, are supplied by means of the layer 22 or the layer 22′. In Biosensor II, the enzyme is supplied by means of the layer 22 or the layer 22′. In Biosensor III, the mediator, and, optionally, a co-enzyme are supplied by means of the layer 22 or the layer 22′. In Biosensor IV, the mediator is supplied by means of the layer 22 or the layer 22′. In Biosensor V, the layer 22 or the layer 22′ is not necessary and can be deleted.

The reagent-containing layer 22, 22′, if used, can be formed from a working ink, which is printed on the layer of conductive material of the working electrode 20, 20′. In addition to being applied to the working electrode 20, 20′, a layer of the working ink can be applied to any of the other electrodes, when desired, as a discrete area having a fixed length. The working ink comprises at least one of an oxidation-reduction mediator, an enzyme, a co-enzyme, or a conductive material. For example, when the analyte to be measured is glucose in blood, an enzyme that can be in the layer 22 or the layer 22′ is preferably glucose dehydrogenase and an oxidation-reduction mediator that can be in the layer 22 or the layer 22′ is preferably a 1,10-phenanthroline-5,6-dione. In one alternative, for the layer 22 or the layer 22′, the printing ink can include a substrate in lieu of an enzyme when the analyte to be measured is an enzyme. The substrate, of course, is catalytically reactive with the enzyme.

Typical analytes of interest include, for example, glucose and ketone bodies. Typical non-reactive electrically conductive materials include, for example, carbon, platinum, palladium, and gold. A semiconducting material such as indium doped tin oxide can be used as the non-reactive electrically conductive material. In the biosensor strips of this invention, the reagent(s) are preferably applied in the form of ink containing particulate material and having binder(s), and, accordingly, does not dissolve rapidly when subjected to the sample. In view of this feature, the oxidation-reduction reaction will occur at the interface of working electrode 20, 20′ and the sample. The glucose molecules diffuse to the surface of the working electrode 20, 20′ and react with the mixture of enzyme and mediator.

The electrode support 12 and the substrate layers 12a′ and 12b′ are preferably made of an inert polymeric material. The portion of the electrode support 12 and the substrate layers 12a′ and 12b′ over which the sample flows is preferably hydrophilic or rendered hydrophilic by a hydrophilic coating material. This type of material for the electrode support 12 and the substrate layers 12a′ and 12b′ or coating material for the electrode support 12 and the substrate layers 12a′ and 12b′ is suitable for use with a sample containing a hydrophilic liquid. When the sample contains a hydrophobic liquid, the portion of the electrode support 12 and the substrate layers 12a′ and 12b′ over which the sample flows is preferably hydrophobic or rendered hydrophobic by a hydrophobic coating material. Representative materials that can be used to form the electrode support 12 and the substrate layers 12a′ and 12b′ include, but are not limited to, poly(vinyl chloride), polycarbonate, and polyester, e.g., poly(ethylene terephthalate), having a hydrophilic coating, polyester, e.g., poly(ethylene terephthalate), subjected to corona-treatment or surfactant-treatment, and poly(vinyl chloride) subjected to corona-treatment or surfactant-treatment. The dimensions of the electrode support 12 and the substrate layers 12a′ and 12b′ are not critical, but a typical layer 12, 12a′, or 12b′ has a length of from about 20 mm to about 40 mm, a width of from about 3 mm to about 10 mm, and a thickness of from about 0.5 mm to about 1 mm. Representative examples of materials suitable for preparing the substrates 12a′, 12b′ include 3M 9971 Hydrophilic PET film and Mitsubishi 4FOG, both of which are formed from poly(ethylene terephthalate). The layer of hydrophilic material allows the sample to wet the surface of the substrates 12a′, 12b′, whereby flow of the sample through the flow channel 34′ is facilitated. Flow of the sample continues until the sample is removed from the flow channel 34′ or the flow channel 34′ consumes the entire sample.

The conductive tracks 14a, 14b, 14a′, 14b′ are made of an electrically conductive material. Representative materials that can be used to form the conductive tracks 14a, 14b, 14a′, 14b′ include, but are not limited to, carbon, platinum, palladium, gold, and a mixture of silver and silver chloride. The tracks 14a, 14b, 14a′, 14b′ determine the positions of electrical contacts 16a, 16b, 16a′, 16b′, respectively, and the electrodes 18, 20, 18′, 20′, respectively. The electrical contacts are insertable into an appropriate measurement device (not shown). An appropriate measurement device is described in U.S. Pat. No. 6,377,894, incorporated herein by reference.

The function of the working electrode 20 or 20′ is to monitor the reaction that takes place in the vicinity of the working electrode 20 or 20′, e.g., the reaction of glucose with glucose oxidase or glucose dehydrogenase. The function of the reference electrode (not shown) is to maintain a desired potential at the working electrode. The function of the counter electrode (not shown) is to provide the necessary current flow at the working electrode 20 or 20′. In this system the counter electrode (not shown) can have the secondary function of a trigger electrode, that is, prevents the assay from beginning until an adequate quantity of sample has filled the volume in the vicinity of the working electrode 20 or 20′.

The reaction that takes place at the working electrode 20 or 20′ is the reaction that is required to be monitored and controlled, e.g., the reaction of glucose with glucose oxidase or with glucose dehydrogenase. The functions of the reference electrode (not shown) and the counter electrode (not shown) are to ensure that the working electrode 20 or 20′ actually experiences the desired conditions, i.e. the correct potential. The potential difference between the working electrode 20 or 20′ and the reference electrode (not shown) is assumed to be the same as the desired potential at the working electrode 20 or 20′.

The electrodes 18, 20, 18′, 20′ are made of an electrically conductive material. Representative materials that can be used to form the electrodes 18, 20, 18′, 20′ include, but are not limited to, carbon, platinum, palladium, and gold. The dual-purpose reference/counter electrode 18, 18′ can optionally contain a layer comprising a mixture of silver and silver chloride. The dimensions of the electrodes 18, 20, 18′, 20′ are not critical, but a typical working electrode has an area of from about 0.5 mm² to about 5 mm², a typical reference electrode has an area of from about 0.2 mm² to about 2 mm², and a typical counter electrode has an area of from about 0.2 mm² to about 2 mm².

The electrodes cannot be spaced so far apart that the dual-purpose reference/counter electrode 18, 18′ and the working electrode 20, 20′ (or in an alternative embodiment, the working electrode, the reference electrode, and the counter electrode) cannot be covered by the sample. It is preferred that the length of the path to be traversed by the sample (i.e., the sample path) be kept as short as possible in order to minimize the volume of sample required. The maximum length of the sample path can be as great as the length of the biosensor strip. However, the corresponding increase in resistance of the sample limits the length of the sample path to a distance that allows the necessary response current to be generated. It is preferred that the distance between the working electrode and the dual-purpose reference/counter electrode (or between the working electrode and the reference electrode or between the working electrode and the counter electrode in an alternative embodiment) not exceed about 200 micrometers.

The elongated portions of the conductive tracks 14a, 14b, 14a′, 14b′ can optionally be overlaid with a track of conductive material, preferably made of a mixture comprising silver particles and silver chloride particles. This optional overlying track results in lower resistance, and consequently, higher conductivity. A layer of an electrically insulating material 26 further overlies the tracks 14a, 14b. In the embodiment employing the dual-purpose reference/counter electrode 18, the layer of electrically insulating material 26 does not cover the positions of the dual-purpose reference/counter electrode 18, the working electrode 20, any third electrode, and the electrical contacts 16a, 16b. In the embodiment employing a working electrode, a reference electrode, and a counter electrode (not shown), the layer of electrically insulating material does not cover the positions of the reference electrode, the working electrode, the counter electrode, and the electrical contacts. This layer of electrically insulating material 26 serves to prevent short circuits.

When this insulating material is hydrophobic, it can cause a hydrophilic liquid sample to be restricted to the exposed electrodes. A preferred insulating material is commercially available as “POLYPLAST” (Sericol Ltd., Broadstairs, Kent, UK).

The reagent(s) typically include a combination of an enzyme (e.g., glucose dehydrogenase or glucose oxidase for a glucose assay), an oxidation-reduction mediator (such as an organic compound, e.g., a phenanthroline quinone, an organometallic compound, e.g., ferrocene or a ferrocene derivative, a coordination complex, e.g., ferricyanide), and a conductive filler material (e.g., carbon) or non-conductive filler material (e.g., silica). Alternatively, instead of an enzyme, the working electrode can contain a substrate that is catalytically reactive with an enzyme to be measured. Enzyme systems that can be used include, but are not limited to:
I. Oxidases, such as, for example, glucose oxidase, lactate oxidase, alcohol oxidase
II. Dehydrogenases, such as, for example, nicotinamide adenine dinucleotide-dependent glucose dehydrogenase or pyrroloquinoline quinone-dependent glucose dehydrogenase, lactate dehydrogenase, alcohol dehydrogenase, β-hydroxy butyrate dehydrogenase
   Mediator systems that can be used in this invention include, but are not limited to, organometallic compounds, such as ferrocene, organic compounds, such as quinones, coordination compounds with inorganic or organic ligands, such as ferricyanide or ruthenium bipyridyl complexes.

In the embodiment shown in FIGS. 4-6, the spacing layer 26′ comprises a material of substantially uniform thickness that can bond to or be bonded to the conductive layer 14a′ printed on the first major surface 32a′ of the substrate 12a′ and to the conductive layer 14b′ printed on the first major surface 32b′ of the substrate 12b′. In one embodiment, the spacing layer 26′ can be printed onto the conductive layer 14b′ printed on the first major surface 32b′ of the substrate 12b′ and bonded by a layer of adhesive 27′ to the conductive layer 14a′ printed on first major surface 32a′ of the substrate 12a′. The spacing layer 26′ can comprise a backing having adhesive material coated on both major surfaces thereof. Examples of backings and adhesives suitable for forming the spacing layer 26′ can be found in Encyclopedia of Polymer Science and Engineering, Volume 13, John Wiley & Sons (1988), pages 345-368, incorporated herein by reference. Alternatively, the spacing layer 26′ can be formed by printing an adhesive onto the conductive layers 14a′ and 14b′ printed on the substrates 12a′ and 12b′, respectively. Adhesives that are suitable for preparing the spacing layer 26′ should be sufficiently resistant to external pressure so that the depth of the spacing layer 26′ is maintained upon exposure of the biosensor strip 10′ to external stress.

The spacing layer 26′ can be prepared in any of several ways. In one embodiment, the spacing layer 26′ can be prepared from a double-sided adhesive tape, i.e., a backing layer having a layer of adhesive on both major surfaces thereof. In another embodiment, the spacing layer 26′ can be formed from an adhesive that is coated onto the conductive layers 14a′ and 14b′ printed on the substrates 12a′ and 12b′, respectively, from an aqueous carrier or from an organic carrier. In still another embodiment, the spacing layer 26′ can be formed from a radiation curable adhesive, preferably ultraviolet radiation curable adhesive, the adhesive being capable of being coated onto the conductive layers 14a′ and 14b′ printed on the substrates 12a′ and 12b′, respectively. The dimensions of the spacing layer 26′ are not critical, but the spacing layer 26′ typically has a length ranging from about 3 mm to about 30 mm and a thickness ranging from about 50 μm to about 200 μm. The spacing layer 26′ forms the sidewalls of the flow channel 34′. A typical width of a flow channel 34′ ranges from about 2 mm to about 5 mm.

The spacing layer 26′ must be adhered to both the conductive layers 14a′ and 14b′ printed on substrate 12a′ and the substrate 12b′, respectively, to maintain the biosensor strip 10′ as an integrated unit. The spacing layer 26′ can be bonded to the conductive layers 14a′ and 14b′ printed on the substrate 12a′ and the substrate 12b′, respectively, by means of adhesive. Embodiments of the spacing layer 26′ include a backing having a layer of adhesive on both major surfaces thereof. The adhesive can be a water-borne adhesive, a solvent-borne adhesive, or a radiation-curable adhesive, preferably an ultra-violet radiation curable adhesive (hereinafter “UV-curable adhesive”). Water-borne adhesives, solvent-borne adhesives, and UV-curable adhesives are preferably screen-printed so that a required design of the spacing layer 26′ is printed on the conductive layer 14a′ printed on the substrate 12a′ or on the conductive layer 14b′ printed on the substrate 12b′. The required design is preferably prepared from a UV-curable adhesive, because the thickness of the spacing layer that will result from curing the uncured layer of UV-curable adhesive corresponds closely to the thickness of the uncured layer of UV-curable adhesive, thereby ensuring the manufacture of a flow channel 34′ having a precisely defined depth.

Commercially available products comprising backings having layers of adhesive on both major surfaces thereof include materials such as TESA 4972 (TESA Tape, Inc., Charlotte, N.C.). Such products are preferably precut before being applied to the substrate 12a′. U.S. Pat. No. 6,207,000 discloses a process for which a spacing layer (double-sided adhesive) is laminated onto a carrier layer and subsequently a contour that determines the shape of the channel is removed from the spacing layer.

Representative examples of water-borne adhesives suitable for use in this invention include materials such as acrylic-based KiwoPrint D-series adhesives (Kiwo, Inc., Seabrook, Tex.). One benefit of water-borne adhesives is that the humidity of the printing environment can be maintained at a desired level to avoid premature drying of the adhesive. One disadvantage of water-borne adhesives is that the depth of the flow channel 34′ is reduced significantly when the aqueous carrier evaporates. In addition, water-borne adhesives may not have sufficient mechanical strength to prevent deformation when subjected to externally applied pressure.

Representative examples of solvent-borne adhesives suitable for use in this invention include materials such as acrylic-based KiwoPrint L-series and TC-series adhesives (Kiwo, Inc., Seabrook, Tex.). Solvent-borne adhesives are more difficult to use than are water-borne adhesives, because evaporation of solvent is more facile than water. In addition, the depth of the flow channel 34′ decreases significantly following removal of solvent.

Representative examples of UV-curable adhesives suitable for use in this invention include materials such as Kiwo UV3295VP (Kiwo, Inc., Seabrook, Tex.), which comprises acrylic acid, benzophenone, isobornyl acrylate, isobornyl methacrylate, proprietary photoinitiator, and proprietary acrylic oligimer and polyesters. Advantages of UV-curable adhesives include resistance to drying under ambient conditions (i.e., external ultraviolet radiation is required to initiate polymerization) and the ability to maintain the thickness of layer immediately following printing throughout the curing process. As mentioned previously, the depth of the flow channel 34′ derived from thickness of water-borne and solvent-borne adhesives decreases upon curing (reduction in the depth of the flow channel 34′ ranges from about 40% to about 70%). The viscosity of the UV-curable adhesive can be modified from the original formulation by the inclusion of fumed silica (Cab-O-Sil M5, Cabot Corporation, Boston, Mass.). The addition of fumed silica (preferably up to 3% by weight) allows viscosity modification without adversely affecting the bonding characteristics of the cured adhesive. The increased viscosity of the ink improves the definition of the walls of the flow channel 34′ by reducing the ability of the ink to spread between the time it is printed and the time it is cured. The thickness of the spacing layer can be controlled by selecting appropriate mesh counts and thread thickness of the screen used for printing these adhesives. Alternatively, the adhesive can be screen printed by means of a stencil screen of desired thickness.

Registration tolerances of a spacing layer 26′ applied by a method of printing are well suited for rapid manufacturing of a sensor having the form of a strip. In particular, the material for forming the spacing layer 26′ can simply be printed at a conveniently located printing station. If the spacing layer 26′ is applied by means of a tape cut from a sheet, it is required that the tape cut from the sheet be placed in the prescribed area of the sensor, so that the adhesive does not cover any area that must remain exposed. Likewise, if the spacing layer 26′ is applied by means of printing of an adhesive, it is required that the adhesive be printed in the prescribed area of the sensor, so that the adhesive does not cover any area that must remain exposed.

The electrodes, the conductive tracks, and the electrical contacts of the biosensor of this invention can prepared by using a screen-printing technique. Reagent(s) that undergo reaction in the determination of the analyte or concentration thereof can be mixed with the conductive ink, along with polyethylene glycol (1%). The loading of the reagents, e.g., enzyme or mediator or both, depends on the nature of the enzyme and the mediator.

Printing inks, such as those described in Table 1, can be applied to the appropriate substrates or to the electrode support to form the electrodes. The printing inks can further include (along with or without a co-enzyme) non-reactive components, such as, for example, one or more polysaccharides (e.g., a guar gum, an alginate, cellulose or a cellulosic derivative, e.g., hydroxyethyl cellulose), one or more hydrolyzed gelatins, one or more enzyme stabilizers (e.g., glutamate or trehalose), one or more film-forming polymers (e.g., a polyvinyl alcohol), one or more conductive fillers (e.g., carbon) or non-conductive fillers (e.g., silica), one or more antifoaming agents (Clerol®, Henkel-Nopco, Leeds, UK), one or more buffers, one or more salts, or a combination of the foregoing.

In the embodiment shown in FIGS. 1-3, the conductive track 14a that is in contact with the working electrode 20 preferably contains at least one reagent, preferably a mediator. This conductive track 14a can be deposited on the insulating substrate 12 by means of a screen-printing technique. The conductive track 14b that is in contact with the dual-purpose reference/counter electrode 18 can be printed as a second track by means of a screen-printing technique, the ink used for printing comprising a mixture of silver and silver halide. A layer of insulating material 26 is preferably printed over the two conductive tracks 14a, 14b so as to define the electrodes 18, 20, i.e., the reaction zone, and the electrical contacts 16a, 16b. A layer of mesh can be placed in the reaction zone to aid in filling the reaction zone with sample by chemically-aided wicking, and the biosensor can be sealed by means of a layer of tape 28 overlying the layer of insulating material 26. If a layer of mesh is not employed, as shown in FIG. 1, a biosensor capable of being filled by capillary attraction can be formed by enclosing the reaction zone with a spacing layer 26 and a tape 28. When the enzyme does not form a part of the working electrode, the enzyme can be applied in a layer on the surface of the working electrode by spray coating, drop coating, or impregnating a mesh or other porous membrane and placing same on the working electrode.

In order to prepare the embodiment shown in FIGS. 1-3, an electrically-conductive ink containing carbon and a mediator in an organic vehicle is printed, preferably by screen-printing, on an electrode support 12 to form a pair of elongated, substantially parallel conductive tracks 14a, 14b. Each of these tracks 14a, 14b is provided with (a) an electrical contact 16a, 16b, respectively, to allow connection of the biosensor to a measurement device and (b) a sample application zone, at which zone the sample containing the analyte to be measured is applied. Material for a reference electrode, such as a mixture of silver and silver chloride, is deposited on a portion of one of the conductive tracks to form a dual-purpose reference/counter electrode 18. Optionally, a layer comprising a mixture of silver and silver chloride can be deposited on the conductive track 14a or 14b between the electrical contact 16a or 16b and the sample application zone to increase the electrical conductivity of the conductive track 14a or 14b. A solution comprising an enzyme is applied on the position where the reaction is to take place and allowed to dry in air. The biosensor can optionally contain a layer of mesh coated with surfactant to disperse the sample uniformly over the sample application zone. The biosensor can further contain a layer of tape applied over the layer of mesh to specify a volume of sample. The volume of sample preferably does not exceed 1 microliter.

In order to prepare the embodiment shown in FIGS. 4-6, an electrically-conductive ink containing carbon and a mediator in an organic vehicle is deposited on one of the major surfaces 32a′ of the first substrate 12a′ to form a working electrode 20′; an electrically-conductive ink containing carbon but no mediator in an organic vehicle is deposited on one of the major surfaces 32b′ of the second substrate 12b′ to form a dual-purpose reference/counter electrode 18′. The surfaces 32a′, 32b′ of the two substrates 12a′, 12b′ are placed in face-to-face arrangement, and the two substrates 12a′ and 12b′ are fastened together by means of the adhesive layer 27′ and the insulating layer 26′, such that the two electrodes 18′ and 20′ are facing each other. As shown in FIGS. 4-6, the insulating layer 26′ is printed on the conductive track 14b′ printed on the surface 32b′ of the substrate 12b′. The adhesive layer 27′ and the insulating layer 26′ have portions cut out to define (a) the electrical contacts 16a′, 16b′ for both of the electrodes 20′, 18′ and (b) a sample application zone. A solution comprising an enzyme is applied on the position where the reaction is to take place and allowed to dry in air. The sample can be introduced to the electrodes 18′, 20′ by capillary attraction. Optionally, layer of mesh can be interposed between the two substrates 12a′, 12b′ to allow the sample to be drawn to the electrodes 18′, 20′ by chemically-aided wicking. The volume of sample for use in this embodiment preferably does not exceed 1 microliter.

In another variation, both the enzyme and the mediator can be incorporated into the conductive track.

If a co-enzyme is used along with the enzyme, the co-enzyme can also be incorporated into the electrically conductive ink. In other variations, the co-enzyme can be applied along with the enzyme in a layer over the portion of the conductive track that functions as an electrode.

In situations where the mediator is known to interact with the enzymes, the mediator and the enzyme must be separated during the preparation of the ink. For example, quinones are known to react with glucose dehydrogenase enzymes, but quinone mediators are desirable because they allow the use of lower voltage for measurement. Accordingly, physical separation of these quinone mediators from the enzyme before the start of the assay is desired. This invention allows the use of, for example, a phenanthroline quinone (PQ) mediator, e.g., 4,7-phenanthroline-5,6-dione, with a quinoprotein enzyme, e.g., pyrroloquinoline quinone, as a co-enzyme. In solution, the quinoprotein enzyme interacts with the PQ mediator, resulting in inactivation of the enzyme. Embedding the PQ mediator in the conductive track enables the use of the quinoprotein enzyme—PQ mediator combination for the measurement of analyte such as glucose. In a conventional biosensor, this enzyme—mediator combination would have resulted in inactivation of the enzyme, unless steps have been taken to isolate enzyme from the mediator.

### Operation

Measuring devices that are suitable for use in this invention include any commercially available analyte monitor that can accommodate an electrochemical cell having a working electrode and a dual-purpose reference/counter electrode. Alternatively, an analyte monitor that can accommodate an electrochemical cell having a working electrode, a reference electrode, and a counter electrode can be used. Such analyte monitors can be used to monitor analytes, such as, for example, glucose and ketone bodies. In general, such a monitor must have a power source in electrical connection with the working electrode, the reference electrode, and the counter electrode. The monitor must be capable of supplying an electrical potential difference between the working electrode and the reference electrode of a magnitude sufficient to cause the electrochemical oxidation of the reduced mediator. The monitor must be capable of supplying an electrical potential difference between the reference electrode and the counter electrode of a magnitude sufficient to facilitate the flow of electrons from the working electrode to the counter electrode. In addition, the monitor must be capable of measuring the current produced by the oxidation of the reduced mediator at the working electrode.

In a measurement employing the electrochemical cell of this invention, a constant voltage is applied at the working electrode and the current is measured as a function of time. This technique is known as chronoamperometry. The voltage applied should be equal or higher to the voltage required to oxidize the reduced mediator. Thus, the minimum voltage required therefore is a function of the mediator.

The sample is responsible for the solution resistance. The solution resistance inhibits the flow of electrons. The effect of solution resistance on the measurement is minimized by this invention. Arranging the electrodes close together obviously minimizes the effect of solution resistance because solution resistance is a function of the spacing between the electrodes. By allowing the current to flow through a different electrode, the effect of solution resistance on the working electrode can be minimized.

In an amperometric measurement, the current should decay with time according to the Cottrell equation.

$${i}_{t} = \frac{n {FAC}_{o} {D}_{o}^{1 / 2}}{{π}^{1 / 2} {t}^{1 / 2}}$$

iₜ=the current at time t
n=number of electrons
F=Faraday's constant
A=area of the electrode
Cₒ=bulk concentration of the electrochemically active species
Dₒ=diffusion coefficient of the electrochemically active species

Therefore, iₜt^{1/2} should be a constant.

In an amperometric measurement, a constant voltage is applied at the working electrode with respect to the reference electrode, and the current between the working and counter electrodes is measured. The response of the electrochemical cell has two components, catalytic (glucose response component) and Faradaic (solution resistance component). If the resistance of the solution is minimized, the response of the electrochemical cell at any given time will have substantially higher glucose response component, as compared with the solution resistance component. Therefore, one is able to obtain good correlation with the concentration of glucose from the response of the electrochemical cell even at assay times as short as one second. If the resistance of the solution is high, the voltage experienced at the working electrode will lag significantly from the voltage applied. This lag is significantly higher for a two-electrode system, as compared with a three-electrode system. In the case of two-electrode system, the value of iR between the working and the reference electrode is significantly higher than that in a three-electrode system. In a three-electrode system, no current flows between the working electrode and the reference electrode, and hence the voltage drop is lower. Therefore, once the charging current (Faradaic current) decays to a minimum (within two to three milliseconds), the current observed is all catalytic current. In a two-electrode system, the charging current is not diminished until the voltage at the working electrode attains a steady state (reaches the applied voltage). Thus, in a two-electrode system, there is a slow decay of the response profile.

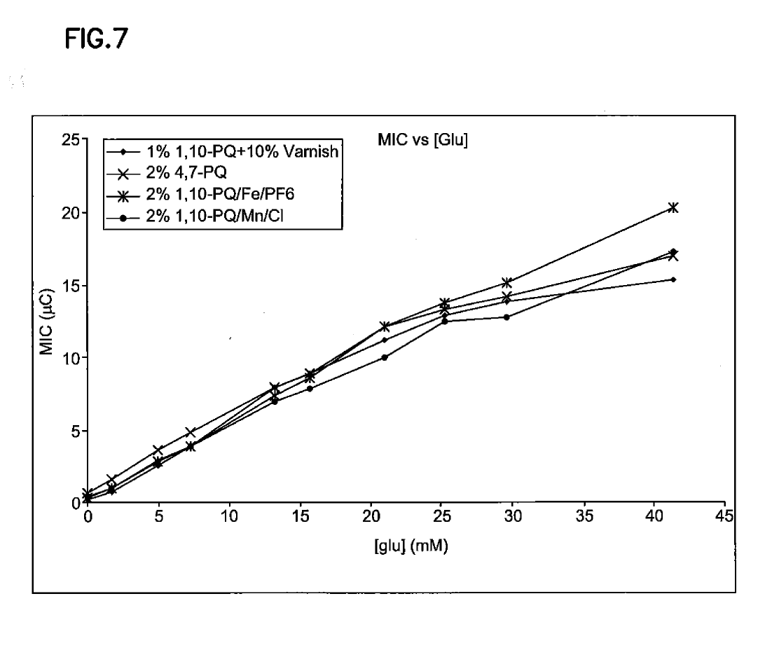

In a preferred embodiment, the biosensor is inserted into a device for measuring the current generated by the reaction between the analyte in the liquid sample and the reagents in the biosensor or some other useful electrical characteristic of the reaction. Then the sample application zone of the biosensor can be filled with a liquid sample by any of numerous methods. Filling can be carried out by, for example, capillary attraction, chemically-aided wicking, or vacuum. One of ordinary skill in the art can specify the type of aperture preferred for introducing the liquid sample into the sample application zone so that the sample can wet the electrodes of the biosensor. Then the current or other electrical characteristic can be measured, and, preferably recorded. FIG. 7 is a graph showing the current response of biosensors as a function of concentration of glucose in blood. In the legend of the graph, 1,10-PQ represents 1,10-phenanthroline quinone; 4,7-PQ represents 4,7-phenanthroline quinone; 1,10-PQ/FE/PF6 represents an iron complex of 1,10-phenanthroline quinone; 1,10-PQ/Mn/Cl represents a manganese complex of 1,10-phenanthroline quinone.

The following non-limiting examples further illustrate this invention.

### EXAMPLES

### Example 1

This example illustrates how a mediator can be incorporated into a conductive track of a biosensor. Ink containing carbon in an organic vehicle was mixed with 2% (w/w) ferrocene. The ink was used to print two tracks on an insulating substrate. A mixture of silver and silver chloride was printed so as to completely cover one of the tracks to form a dual-purpose reference/counter electrode and to partially cover the other track to form a working electrode. The working electrode had a small gap between itself and the silver/silver chloride coating so that silver would not contaminate the reaction zone of the working electrode. A perforated material, a surfactant (FC170, commercially available from 3M) coated mesh (NY64, from Sefar America), was deposited over a portion of both electrodes. An insulating layer, “POLYPLAST”, was printed over the conductive layers so as to expose an area that would make removable contact with a measuring device and an area where the liquid sample is to be applied to the biosensor. A solution of glucose oxidase containing two units of the enzyme was dispensed over the area where the liquid sample is to be applied. The solution of enzyme was air-dried and the biosensor was then used to measure the glucose response.

### Example 2

This example is identical to Example 1, with the exception that the mediator used was tris (1,10-phenanthroline-5,6-dione) manganese (II) chloride and the enzyme used was pyrroloquinoline quinone-dependent glucose dehydrogenase.

### Example 3

This example is identical to Example 2, with the exception that the mediator was added to the carbon-containing ink. Nicotinamide adenine dinucleotide-dependent glucose dehydrogenase and nicotinamide adenine dinucleotide [2.5% (w/w)] were deposited on the working area.

### Example 4

This example is identical to Example 2, with the exception that the mediator and nicotinamide adenine dinucleotide [2.5% (w/w)] were added to the carbon-containing ink. Nicotinamide adenine dinucleotide-dependent glucose dehydrogenase was used as the enzyme.

### Example 5

This example illustrates an electrode arrangement where the working electrode and the dual-purpose reference/counter electrode are in face-to-face relationship. Ink containing carbon in an organic vehicle was mixed with tris (1,10-phenanthroline-5,6-dione) manganese (II) chloride [2% (w/w)] and nicotinamide adenine dinucleotide [2.5% (w/w)]. The ink was used to print a conductive track on one major surface of an insulating substrate. An electrode comprising a mixture of silver and silver chloride was printed on one major surface of a second insulating substrate. A layer of mesh was positioned over the carbon-containing layer and an insulating layer was deposited over the layer of mesh so as to define the electrical contacts and the sample application zone. A solution of nicotinamide adenine dinucleotide-dependent glucose dehydrogenase containing 2 units of the enzyme was dispensed over the area where the sample is to be applied. The solution of enzyme was air-dried and the biosensor was then used to measure the glucose response.

Various modifications and alterations of this invention will become apparent to those skilled in the art without departing from the scope and spirit of this invention, and it should be understood that this invention is not to be unduly limited to the illustrative embodiments set forth herein.

1.-28. (canceled)

29. A biosensor for determining the concentration of a ketone body in a liquid sample, said biosensor comprising:
(a) an electrode support;
(b) an arrangement of electrodes on the electrode support, the arrangement of electrodes comprising at least a working electrode comprising conductive ink and at least one enzyme mixed with the conductive ink, the working electrode free of any mediator, and at least a second electrode;
(c) a first conductive track leading from the working electrode to an electrical contact associated with the working electrode, the conductive track comprising the conductive ink and the at least one enzyme mixed with the conductive ink, the conductive track free of any mediator;
(d) a second conductive track leading from the second electrode to an electrical contact associated with the at least second electrode; and
(e) wherein in the presence of a ketone body, current is measured at the working electrode.

30. The biosensor of claim 29, the biosensor requiring no more than 1 microliter of sample to trigger an electrochemical reaction.

31. The biosensor of claim 29, wherein spacing between the working electrode and the at least second electrode does not exceed about 200 micrometers.

32. The biosensor of claim 29, wherein the electrode arrangement further comprises a trigger electrode.

33. The biosensor of claim 29, further comprising an insulating layer overlying the electrode arrangement.

34. The biosensor of claim 33, wherein a capillary space is interposed between the electrode arrangement and the insulating layer.

35. The biosensor of claim 29, wherein the at least one enzyme is a dehydrogenase.

36. The biosensor of claim 35, wherein the dehydrogenase is β-hydroxy butyrate dehydrogenase.

37. A biosensor for determining the concentration of a ketone body in a liquid sample, said biosensor comprising:
(a) an electrode support;
(b) an arrangement of electrodes on the electrode support, the arrangement of electrodes comprising at least a working electrode comprising conductive ink and at least one enzyme mixed with the conductive ink, and at least a second electrode;
(c) a flow channel in contact with the electrode arrangement, the flow channel defining a capillary space;
(d) a first conductive track leading from the working electrode to an electrical contact associated with the working electrode, the conductive track comprising the conductive ink and the at least one enzyme mixed with the conductive ink;
(e) a second conductive track leading from the second electrode to an electrical contact associated with the at least second electrode; and
(f) wherein in the presence of a ketone body, current is measured at the working electrode.

38. The biosensor of claim 37, the working electrode further comprising at least one mediator mixed with the conductive ink, and the first conductive track comprising the at least one mediator mixed with the conductive ink.

39. The biosensor of claim 38, wherein the at least one mediator is selected from the group consisting of organometallic compounds, organic compounds, and coordination compounds with inorganic or organic ligands.

40. The biosensor of claim 37, the biosensor requiring no more than 1 microliter of sample to trigger an electrochemical reaction.

41. The biosensor of claim 37, wherein spacing between the working electrode and the at least second electrode does not exceed about 200 micrometers.

42. The biosensor of claim 37, wherein the electrode arrangement further comprises a trigger electrode.

43. The biosensor of claim 37, further comprising an insulating layer overlying the electrode arrangement.

44. The biosensor of claim 43, wherein the capillary space is interposed between the electrode arrangement and the insulating layer.

45. The biosensor of claim 37, wherein the at least one enzyme is a dehydrogenase.

46. The biosensor of claim 45, wherein the dehydrogenase is β-hydroxy butyrate dehydrogenase.

47. A biosensor for determining the concentration of a ketone body in a liquid sample, the biosensor comprising:
(a) a first substrate having two major surfaces;
(b) a second substrate having two major surfaces;
(c) a working electrode disposed on one major surface of the first substrate, the working electrode comprising a conductive ink and at least one enzyme mixed with the conductive ink, the working electrode free of any mediator;
(d) at least a second electrode disposed on one major surface of the second substrate;
(e) a first conductive track leading from the working electrode to an electrical contact associated with the working electrode, the conductive track comprising the conductive ink and at least one enzyme mixed with the conductive ink, the conductive track free of any mediator;
(f) a second conductive track leading from the second electrode to an electrical contact associated with the at least second electrode; and
(g) an insulating layer disposed between the working electrode and the at least second electrode; wherein the major surface bearing the working electrode faces the major surface bearing the at least second electrode, and wherein in the presence of a ketone body, current is measured at the working electrode.

48. The biosensor of claim 47, the biosensor requiring no more than 1 microliter of sample to trigger an electrochemical reaction.

49. The biosensor of claim 47, wherein spacing between the working electrode and the at least one other electrode does not exceed about 200 micrometers.

50. The biosensor of claim 47, wherein the electrode arrangement further comprises a trigger electrode.

51. The biosensor of claim 47, wherein a capillary space is interposed between the working electrode and the insulating layer.

52. The biosensor of claim 47, wherein the at least one enzyme is a dehydrogenase.

53. The biosensor of claim 52, wherein the dehydrogenase is β-hydroxy butyrate dehydrogenase.
